(19) United States
(12) Patent Application Publication
(10) Pub. No.: US 2007/0097054 A1
(43) Pub. Date: May 3, 2007

(54) METHOD FOR DRIVING A THIN FILM TRANSISTOR LIQUID CRYSTAL DISPLAY

(76) Inventor: Jung-Chieh Cheng, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,722

(22) Filed: Oct. 28, 2005

(51) Int. Cl. G09G 3/36

(52) U.S. Cl. 345/96

(57) ABSTRACT

A method for driving a thin film transistor liquid crystal display (TFT LCD) not only accelerates a response speed of the liquid molecules, but applies to the highest and the lowest margin voltage as well. In addition, this method comprises the following steps: during a period of a changing of one sub-pixel's data, when the sub-pixel is positive-polarity driven, lowering a common voltage of the sub-pixel and raising its source line voltage at the same time; and when the sub-pixel is negative-polarity driven, raising the its common voltage common voltage of the sub-pixel and lowering its source line voltage at the same time.

### BACKGROUND OF THE INVENTION

1. Field of the Invention

The present invention generally relates to a method for driving a thin film transistor display (TFT LCD), and more particularly, to a method for driving a TFT LCD by implementing a driving polarity of sub-pixel (or called “dot”) to change a common voltage.

2. Description of Related Art

Image displayed by the TFT LCD consists of colours emitting from a large number of pixels, wherein each pixel further comprises a red, a green and a blue sub-pixels. FIG. 1 schematically shows a circuit for driving a sub-pixel of a typical TFT LCD. In a conventional method for driving the sub-pixel, a gate line (GL) supplies a conducting-signal cycle to a thin film transistor, wherein a storage capacitor Cs and a liquid crystal capacitor C_{LC} contained in the sub-pixel, are charged by a data voltage supplied by a source line (SL) that determines a brightness of the sub-pixel.

In recent, as the typical TFT LCD has a main trend in its large size and high resolution, a GL-conducting cycle necessitates to be shorter in order to reduce time required for charging the capacitors. Furthermore, a TFT LCD TV (television) easily produces residual image if a charging for capacitors is not completed in a prescribed time, when displaying moving pictures. Therefore, the crucial factor that affects the image quality is a response speed of liquid crystal molecules. In addition, one method for improving the response speed is to change a driving way of these liquid crystal molecules, thereby accelerating their rotation.

FIG. 2 schematically shows three ways for driving the sub-pixel. In addition, a traditional driving way is a currently-implemented driving way in which a source line voltage V_{SL} input from the source line (SL) is an accurate grey-adjusted voltage V_{data}. Moreover, since the accurate grey-adjusted voltage V_{data} is a voltage that doesn't make any amendment to the driving voltage, it easily experiences the aforementioned problems.

The second driving way is an overdriving way, in which prior to displaying the first frame during the transition of grey scales, a higher (or lower) grey-adjusted voltage V_{OD} is input to accelerate charging the liquid crystal molecules till a sufficient brightness T of a sub-pixel is obtained, followed by being switched to an accurate grey-adjusted voltage V_{data}. Although a charging rate of partial grey-scale can be accelerated, no any accelerating function can be applied to the highest (or the lowest) grey-adjusted voltage because it is a margin voltage in a display range and limited by a source driver.

Furthermore, FIG. 3 schematically shows an overdriving circuit, which comprises a TFT LCD panel 310, a timing controller 302, a look-up unit 303, a gamma circuit 304, a source driver 305 and a gate driver 306. In addition, the look-up unit 303 is responsible for providing a look-up table that allows the timing controller 302 to find out a corresponding grey-adjusted voltage V_{OD} in accordance with data of the sub-pixel in a current frame and a previous frame.

Finally, the third driving way is an overdriving way, which is similar to the overdriving way except that a voltage V_{OS} input into the first frame is higher than the grey-adjusted voltage V_{OD} in order to allow the voltage crossing the capacitor and the sub-pixel brightness to have an overshoot action. Besides, the higher voltage is able to accelerate a charging rate and the brightness' overshooting can be used to compensate a brightness loss during an initial-charging period. However, the overdriving way experiences the same problem as the overdriving way. That is, they are not able to deal with the highest and the lowest margin voltage.

### SUMMARY OF THE INVENTION

Accordingly, the present invention is directed to provide a method for driving a TFT LCD, which not only accelerates a response speed of the liquid molecules, but applies to the highest and the lowest margin voltage as well.

To achieve the aforementioned objective and other objectives, the present invention provides a method for driving a TFT LCD, which comprises the following steps: when a sub-pixel is positive-polarity driven, lowering a common voltage of the sub-pixel by a preset value; and when a sub-pixel is negative-polarity driven, raising the common voltage of the sub-pixel by the preset value.

In one embodiment implementing the aforementioned method for driving the TFT LCD, when the sub-pixel is positive-polarity driven, its common voltage is equal to a reference voltage subtracting the aforementioned preset value. More, when the sub-pixel is negative-polarity driven, its common voltage is equal to the reference voltage plus the aforementioned preset value.

In one embodiment implementing the aforementioned method for driving the TFT LCD, if the data of the sub-pixel in a current frame is not the same as that in a previous frame, a driving bias of the sub-pixel at this time is equal to an overshooting voltage plus a reference voltage and the aforementioned preset value. The data voltage is an accurate capacitor-crossing voltage to which the data of the sub-pixel in a current frame corresponds.

In one embodiment implementing the aforementioned method for driving the TFT LCD, if the data of the sub-pixel in a current frame is the same as that in a previous frame, a driving bias of the sub-pixel at this time is equal to the previous data voltage.

The aforementioned method for driving the TFT LCD, in implementing a driving configuration of a dot inversion, provides the sub-pixels having different driving polarities with two kinds of different common voltages by utilizing two common electrodes' being interlaced on each scan line of the TFT LCD. In addition, when entering the nest scan line, these two common electrodes respectively switch to another corresponding driving polarity common voltage to match a dot inversion's driving configuration.

In one preferred embodiment of the present invention, the aforementioned method for driving the TFT LCD, during the data of sub-pixel's changing period, lowers the common voltage and raises the source line voltage at the same time if the sub-pixel is positive-polarity driven, as well as raises the common voltage and lowers the source line voltage at the same time if the sub-pixel is negative-polarity driven. As a result, a driving bias with a voltage higher than the overdriving is formed, thereby allowing the liquid molecules to respond quickly, to be suitable for the TFT LCD with a larger size and high resolution, and to be suitable for display moving pictures, as well as to reduce overshooting's time to maintain the accurate data voltage longer. In addition, the lowering or raising of the common voltage can allow the source driver to accelerate providing the highest and the lowest voltage.

The objectives, other features and advantages of the invention will become more apparent and easily understood from the following detailed description of the invention when taken in conjunction with the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically shows a circuit for driving a sub-pixel of a typical TFT LCD.

FIG. 2 schematically a method for driving the sub-pixel of the TFT LCD.

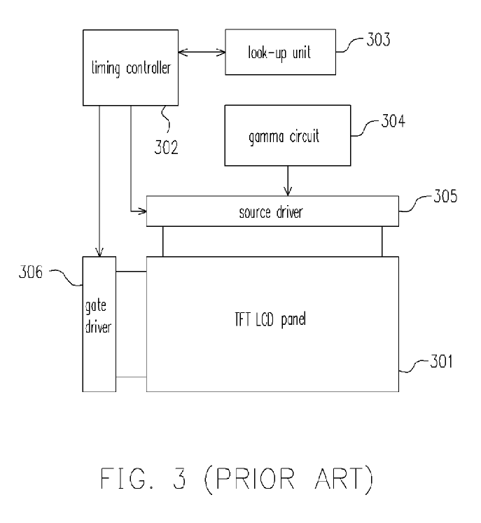

FIG. 3 schematically shows a conventional circuit for driving the conventional TFT LCD.

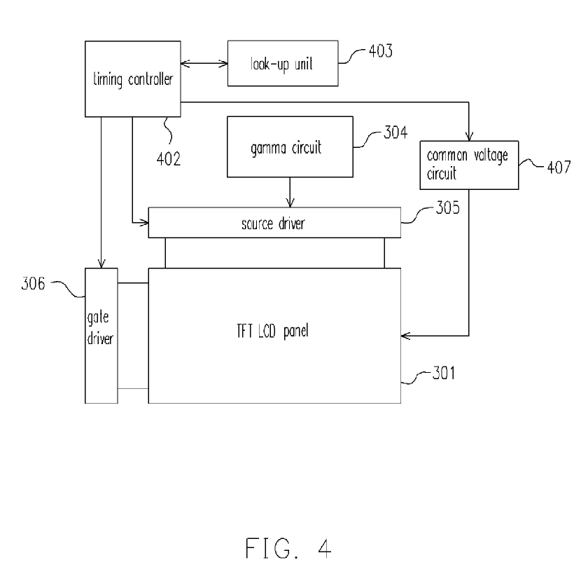

FIG. 4 schematically shows a circuit for driving the TFT LCD, according one embodiment of the present invention.

FIG. 5 and FIG. 6 schematically show a method for driving the TFT LCD, according one embodiment of the present invention.

FIG. 7 shows a flowchart for a driving method for driving the TFT LCD, according one embodiment of the present invention.

FIG. 8 schematically shows a common voltage according one embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same parts.

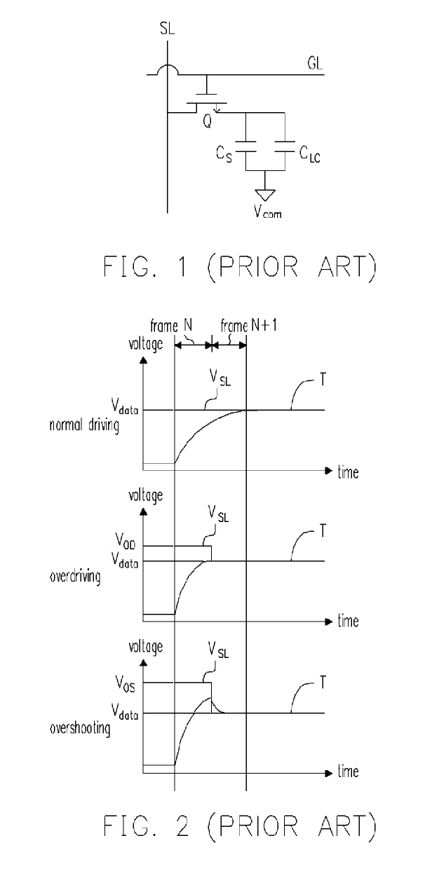

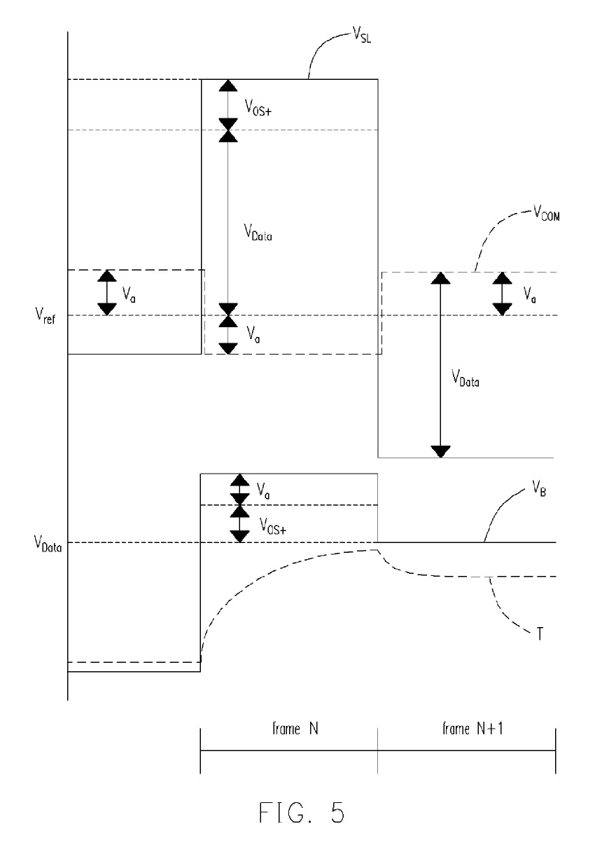

A sub-pixel circuit implemented in this embodiment is identical to that shown in FIG. 1. Besides, a circuit for driving the TFT LCD is shown in FIG. 4 and comprises a TFT LCD panel 310, a timing controller 402, a look-up unit 403, a gamma circuit 304, a source driver 305, a gate driver 306 and a common voltage circuit 407. The common voltage in this embodiment must match the driving polarity of the sub-pixel and swings upwardly and downwardly. In addition, this common voltage is obtained from the common voltage circuit 407. Furthermore, some amendments are made to the timing controller 402 and the look-up unit 403 and the details are described latterly.

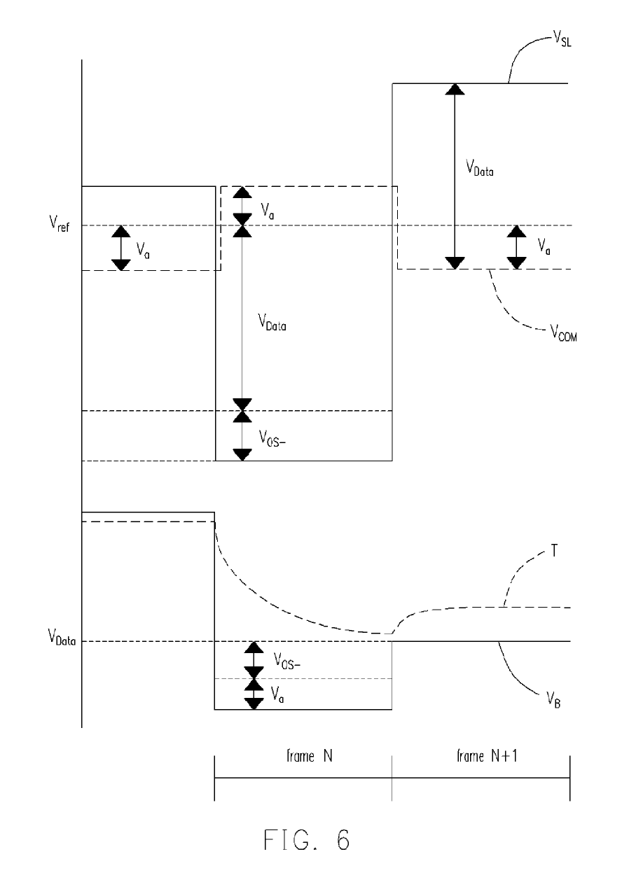

Referring to FIG. 5, it shows one sub-pixel's driving bias when positive polarity driven. So called “driving bias” is referred to a difference value between a source line voltage over a source line and a common voltage Vcom. That is, the difference value is a bias applied to the storage capacitor of the sub-pixel and two terminal of the liquid crystal capacitor C_{LC.}

First of all, during a frame N, as the data of the sub-pixel in the frame N is not equal to that in a frame N−1, to accelerating charging the capacitors, the common voltage Vcom is lowered to be a reference voltage Vref subtracting a preset voltage Va and the source line voltage V_{SL} is added an overshooting voltage V_{OS+}, in addition to increment of an accurate data voltage Vdata. It is noticeable that in order to distinguish between the source line voltage V_{SL} and the common voltage Vcom, a little separation between them is shown in FIG. 5; however, their voltage variations are synchronous.

The aforementioned overshooting voltage V_{OS+} is obtained by searching a look-up table contained in the look-up unit 403 in accordance with the data of the sub-pixel in a current frame (i.e. frame N) and in a previous frame( i.e. frame N−1). As the overshooting voltage V_{OS+} may not be the same as the conventional overdriving plus overshooting, the look up table comprised in the look up unit 403 is different from that comprised in the look up unit 303 and accordingly can not apply to different TFT LCD panels. As to the data voltage Vdata, it is referred to the accurate capacitor voltage to which the data of the sub-pixel in the current frame corresponds, and to the capacitor-crossing voltage required for displaying the accurate grey scale corresponding to the current data.

As shown in FIG. 5, the source line voltage V_{SL} and the common voltage Vcom in the frame N, cause a driving bias V_{B} of the sub-pixel to be equal to the overshooting voltage V_{OS+} plus the data voltage Vdata and the preset voltage Va. Moreover, the driving bias is larger than the conventional overdriving, as well as larger than the conventional overshooting due to the common voltage's facilitation. Therefore, this driving way is called “super overshooting.” The larger driving bias V_{B} enables the capacitors to be charged more quickly so as to reduce time required by the source line's sending out overshooting voltage V_{OS+} and thereby maintain the accurate driving bias longer. In addition, the super overshooting has the same function as the overshooting to allow the sub-pixel's brightness T to have an overshoot action that compensates a brightness loss during an initial charging period.

Regarding to the conventional driving method, when the driving circuit is positive polarity driven and the source driver intends to send the highest data voltage Vdata corresponding to the highest grey scale, the highest data voltage Vdata has no capacity to accommodate the overshooting voltage V_{OS+}, so that the highest margin voltage can not be increased any more and thereby fails to accelerate the response speed of the liquid crystal molecules. However, in the driving method provided by the present invention, even if the source driver is not able to send the overshooting voltage V_{OS+}, the common voltage still can be lowered to accelerating charging the capacitors. When the driving circuit is positive polarity driven, the present invention also can raise the common voltage Vcom to enhance the driving bias V_{B}. This is a reason why the present invention is capable of enhancing the highest and lowest margin voltage (here, the “enhancing” is referred to increase a range of the highest and lowest margin voltage).

Subsequently, the sub-pixel is driven to enter into a frame N−1 and then switched to be negative polarity driven. In FIG. 5, the data of the frame N+1 is the same as that of the frame N so that the driving bias V_{B} is only maintained at the accurate data voltage Vdata. When data of the sub-pixel in the current frame is the same as that in the previous frame (i.e. it does not need to be overdriven), the timing controller 402 is amended to provide a grey-scale voltage supplied to the source driver 305 to offset an effect caused by the common voltage's variation. As shown in FIG. 5, the common voltage at this time is equal to the reference voltage Vref plus the preset voltage Va, and the source line voltage V_{SL} is equal to the reference voltage Vref subtracting the data voltage Vdata and then plus the preset voltage Va.

Referring to FIG. 6, it shows the driving bias V_{B} of the same sub-pixel when negative polarity driven. FIG. 6 is substantially the same as FIG. 5 except that the super overshooting is needed if data of the frame N is not the same as that of the frame N−1, and overshooting is not needed if data of the frame N is the same as that of the frame N−1. That is, FIG. 5 and FIG. 6 have an opposite polarity driven during the same frame period so that the source line voltage V_{SL} and the common voltage Vcom are upwardly and downwardly inversed centred on the reference voltage.

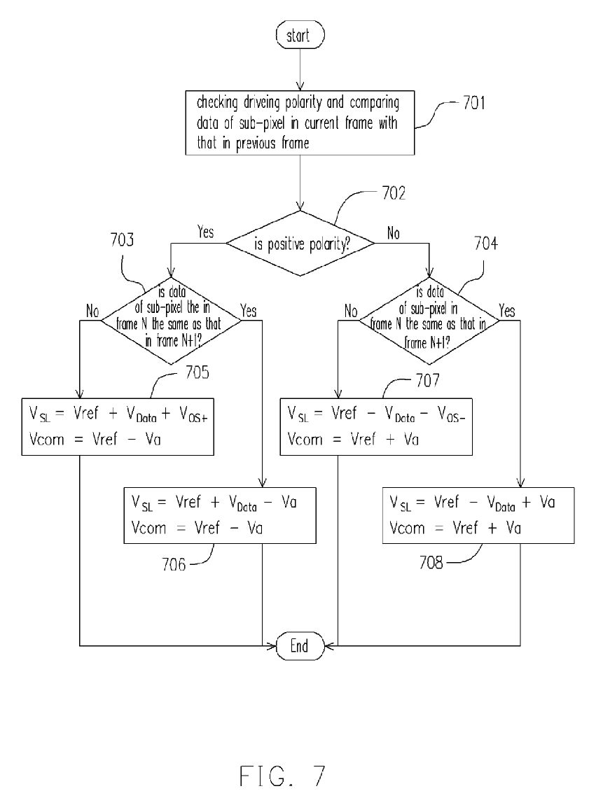

The aforementioned driving method can be explained in a flowchart shown in FIG. 7. Namely, FIG. 7 is a flowchart according to the method for driving the TFT LCD of the embodiment. First of all, a step 701 performs checking a driving polarity of the sub-pixel and whether the data of sub-pixel in the current frame is the same as that in the previous frame. The following procedures are classified into four cases.

In the first case, if the sub-pixel is positive polarity driven and data of the current frame is not the same as that of the previous frame, the flowchart proceeds to pass steps 702 and 703 and then enter into a step 705. At this time, the source line voltage V_{SL} is raised to be the reference voltage Vref plus the data voltage Vdata and the overshooting voltage V_{OS+} while the common voltage Vcom is lowered to be the reference voltage Vref subtracting the preset voltage Va. As a result, the driving bias V_{B} is equal to the source line voltage V_{SL} subtracting the common voltage Vcom; in other words, it is equal to V_{OS+}+Vdata+Va, as shown in the frame N in FIG. 5.

In the second case, if the sub-pixel is positive polarity driven and data of the current frame is not the same as that of the previous frame, the flowchart proceeds to pass steps 702 and 703 and then enter into a step 706. At this time, the source line voltage V_{SL} is amended to be the reference voltage Vref plus the data voltage Vdata and the overshooting voltage V_{OS+} while the common voltage Vcom is lowered to be the reference voltage Vref subtracting the preset voltage Va. As a result, the driving bias V_{B} is equal to the source line voltage V_{SL} subtracting the common voltage Vcom; in other words, it is equal to the data voltage Vdata, as shown in the frame N+1 in FIG. 6.

In the third case, if the sub-pixel is negative polarity driven and data of the current frame is not the same as that of the previous frame, the flowchart proceeds to pass steps 702 and 704 and then enter into a step 707. At this time, the source line voltage V_{SL} is lowered to be the reference voltage Vref subtracting the data voltage Vdata and the overshooting voltage V_{OS+} while the common voltage Vcom is raised to be the reference voltage Vref plus the preset voltage Va. As a result, the driving bias V_{B} is equal to the common voltage Vcom subtracting the source line voltage V_{SL}; in other words, it is equal to V_{OS+}+Vdata+Va, as shown in the frame N in FIG. 6.

In the fourth case, if the sub-pixel is negative polarity driven and data of the current frame is the same as that of the previous frame, the flowchart proceeds to pass steps 702 and 704 and then enter into a step 708. At this time, the source line voltage V_{SL} is amended to be the reference voltage Vref subtracting the data voltage Vdata and then plus the overshooting voltage V_{OS+} while the common voltage Vcom is raised to be the reference voltage Vref plus the preset voltage Va. As a result, the driving bias V_{B} is equal to the common voltage Vcom subtracting the source line voltage V_{SL};in other words, it is equal to the data voltage Vdata, as shown in the frame N+1 in FIG. 5.

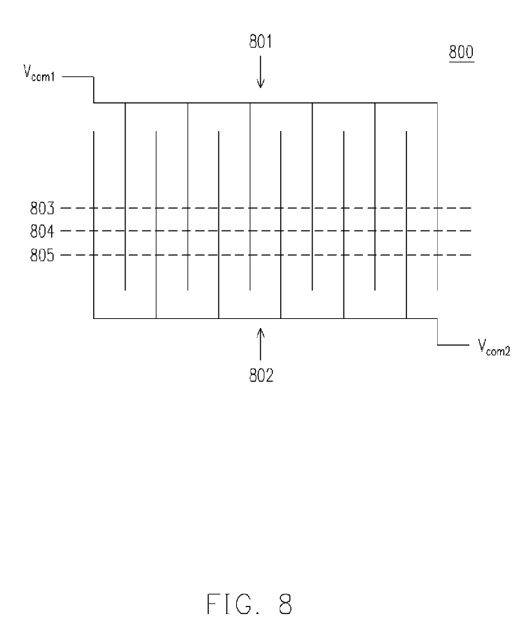

The driving method of the embodiment is suitable for driving configurations of frame inversion, line inversion, and dot inversion. In frame inversion and line inversion, the sub-pixels on the same scan line are situated together at either negative polarity driven or positive polarity driven so that they can share the common voltage. However, the dot inversion needs complicated procedures, as shown in FIG. 8.

A TFT LCD panel 800 shown in FIG. 8 comprises two common electrodes 801 and 802, which respectively supply two kinds of different common voltages Vcom1 and Vcom2. For each scan line on the TFT LCD panel 800, such as scan lines 803 to 805, the common electrodes 801 and 802 are interlaced along the scan lines. Therefore, on the same scan line, the sub-pixels having different driving polarities can be provided with two kinds of different common voltages. For example, the sub-pixel having positive driving polarity uses the common voltages Vcom1 and the sub-pixel having negative driving polarity uses the common voltages Vcom2. Evidently, when the common voltages Vcom1 and Vcom2 enter the next scan line for each time, they are switched to common voltages corresponding to another driving polarity to match the driving configuration of the sub-pixel inversion.

In summary, the method for driving the TFT LCD of the present invention, during the data of sub-pixel's changing period, lowers the common voltage and raises the source line voltage at the same time when the sub-pixel is positive-polarity driven, as well as raises the common voltage and lowers the source line voltage at the same time when the sub-pixel is negative-polarity driven. As a result, a driving bias with a voltage higher than the overdriving is formed, thereby allowing the liquid molecules to respond quickly, to be suitable for the TFT LCD with a larger size and high resolution, and be suitable for display moving pictures, as well as reduce overshooting's time to maintain the accurate data voltage longer. In addition, the lowering or raising of the common voltages can allow the source driver to accelerate providing the highest and the lowest voltage.

In addition to the aforementioned applications and advantages, the method for driving the TFT LCD of the present invention can be used to accelerate inserting black pictures (i.e. brightness integration function for amending human eyes' perception). When a voltage of the inserted black pictures is the highest or the lowest margin voltage, the method of the present invention can be used to accelerate the response speed of the liquid crystal molecules and thereby make the inserted black pictures have the same brightness. Furthermore, the method of the present invention can be applied to an LCD with an optically compensated bend (OCB) mode. As a capacitor-crossing voltage required by the OCB LCD is much larger than that required by a general LCD, the method of the present invention can be used to provide a larger capacitor-crossing voltage when the capacitor-crossing voltage exceeds a voltage supplied by the source driver.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for driving a thin film transistor crystal display, the method comprising the following steps:
lowering a common voltage of a sub-pixel by a preset value when the sub-pixel is positive-polarity driven; and
raising the common voltage of the sub-pixel by the preset value when the sub-pixel is negative-polarity driven.

2. The method for driving a thin film transistor crystal display according to claim 1, wherein the common voltage of the sub-pixel is equal to a reference voltage subtracting the preset value when the sub-pixel is positive-polarity driven, and the common voltage of the sub-pixel is equal to the reference voltage plus the preset value when the sub-pixel is negative-polarity driven.

3. The method for driving a thin film transistor crystal display according to claim 2, wherein if the data of the sub-pixel in a current frame is not the same as that in a previous frame, a driving bias of the sub-pixel is equal to an overshooting voltage plus a data voltage and the preset value, and the data voltage is an accurate capacitor-crossing voltage to which the data of the sub-pixel in a current frame corresponds.

4. The method for driving a thin film transistor crystal display according to claim 3, wherein the overshooting voltage is obtained by searching a look-up table in accordance with the data of the sub-pixel in a current frame and in a previous frame.

5. The method for driving a thin film transistor crystal display according to claim 3, wherein a source line voltage of the sub-pixel is equal to the reference voltage plus the data voltage and the overshooting voltage when the sub-pixel is positive-polarity driven.

6. The method for driving a thin film transistor crystal display according to claim 3, wherein a source line voltage of the sub-pixel is equal to the reference voltage subtracting a sum of the data voltage and the preset value when the sub-pixel is negative-polarity driven.

7. The method for driving a thin film transistor crystal display according to claim 2, wherein if the data of the sub-pixel in a current frame is the same as that in a previous frame, a driving bias of the sub-pixel is equal to a data voltage, and the data voltage is an accurate capacitor-crossing voltage to which the data of the sub-pixel in a current frame corresponds.

8. The method for driving a thin film transistor crystal display according to claim 7, wherein a source line voltage of the sub-pixel is equal to the reference voltage plus the data voltage and then subtracting the preset value voltage when the sub-pixel is positive-polarity driven.

9. The method for driving a thin film transistor crystal display according to claim 7, wherein a source line voltage of the sub-pixel is equal to the reference voltage subtracting the data voltage and then plus the preset value voltage when the sub-pixel is negative-polarity driven.

10. The method for driving a thin film transistor crystal display according to claim 1, wherein the thin film transistor crystal display implements a driving configuration of a dot inversion.

11. The method for driving a thin film transistor crystal display according to claim 1, wherein the thin film transistor crystal display implements a driving configuration of a line inversion.

12. The method for driving a thin film transistor crystal display according to claim 1, wherein the thin film transistor crystal display implements a driving configuration of a sub-pixel inversion.

13. The method for driving a thin film transistor crystal display according to claim 12, wherein the thin film transistor crystal display further comprises a first common electrode and a second common electrode, which are interlaced on each scan line of the thin film transistor crystal display and provides the sub-pixels having different driving polarities with two kinds of different common voltages.

14. The method for driving a thin film transistor crystal display according to claim 13, wherein when the common voltages of the first common electrode and the second common electrode enter the next scan line for each time, they are switched to common voltages corresponding to another driving polarity to match the driving configuration of the sub-pixel inversion.
